(19) United States
(12) Patent Application Publication
(10) Pub. No.: US 2010/0274537 A1
(43) Pub. Date: Oct. 28, 2010

(54) Stress-based Topology Optimization Method and Tool

(75) Inventors: Chau H. Le, Hanoi (VN); Julian A. Norato, Urbana, IL (US); Tyler E. Bruns, Champaign, IL (US); Christopher Ha, Champaign, IL (US); Daniel Tortorelli, Champaign, IL (US)

Correspondence Address: Caterpillar Inc.;c/o Miller, Matthias & Hull, One North Franklin Street, Suite 2350, Chicago, IL, 60606, US

(73) Assignee: CATERPILLAR, INC., Peoria, IL (US)

(21) Appl. No.: 12/767,598

(22) Filed: Apr. 26, 2010

Related U.S. Application Data
(60) Provisional application No. 61/172,400, filed on Apr. 24, 2009.

(51) Int. Cl. G06F 17/50

(52) U.S. Cl. 703/1

(57) ABSTRACT

A method (10) for performing stress-based topology optimization of a structure (2, 102, 202) on a computational device (302) is provided. Upon receiving a problem definition of the structure (2, 102, 202) from an input device (304) coupled to an input of the computational device (302), the method (10) may generate a density filter, interpolation schemes for stiffness, volume and stress, a global stress measure, an adaptive normalization scheme and a regional stress measure, to determine an optimized stress-based solution to the problem defined. The method (10) may further enable the optimized solution to be rendered for display at an output device (306) coupled to an output of the computational device (302).

### CROSS-REFERENCE TO RELATED APPLICATION

This is a non-provisional application claiming priority under 35 U.S.C. 119(e) to U.S. Provisional Patent Application Ser. No. 61/172,400 filed on Apr. 24, 2009.

### TECHNICAL FIELD

This disclosure relates generally to systems and methods for performing stress-based topology optimization.

### BACKGROUND

Topology optimization is well known in the art of structural design and is commonly used for optimizing the structural characteristics of a given material. More specifically, topology optimization employs a mathematical approach which aids design engineers in optimizing the distribution of a material for a given set of loads and boundary conditions so as to meet structural target performance requirements. There are several different techniques for conducting topology optimization. Among those, the material distribution technique has been well established and proven adequate in industries worldwide. However, the developments in the material distribution technique relies more upon compliance and other global response constraints, such as frequency, when in fact stress is one of the more important considerations. This is because developing an effective stress-based topology optimization method requires overcoming at least three well known challenges including the singularity phenomenon, the local nature of constraints and highly nonlinear stress behaviors.

The first challenge pertaining to the singularity phenomenon was first introduced while designing trusses which were subjected to various stress constraints. In doing so, it was shown that an n-dimensional feasible design space contains degenerate subspaces of dimensions less than n. The globally optimal design is often an element of such degenerate subspaces. However, because nonlinear programming algorithms cannot identify such regions, they tend to converge to locally optimal designs. In order to overcome such drawbacks, the stress constraints were relaxed to eliminate the degenerate regions, and thus, to allow the nonlinear programming algorithms to determine the global optimum design. Several such relaxation approaches have been defined for use with truss design including, for example, the ε-relaxation and smooth envelope functions (SEFs). These approaches were also adapted for the stress constrained design of continuum structures.

The second challenge of stress-based topology optimization pertains to the local nature of stress constraints. In an ideal continuum setting, stress constraints should be considered at every material point. Although finite, the number of such material points is still too large for practical applications. One resolution to accommodate for this setback is to replace the local stress constraints with a single integrated stress constraint that approximates the maximum stress value, as with the p-norm and the Kresselmeier-Steinhauser (KS) functions. While such global approaches are computationally efficient, they do not adequately control the local stress behaviors.

The third challenge associated with stress-based topology optimization pertains to the highly nonlinear dependence of stress constraints on the structure or design in question. It is well known that stress levels are significantly affected by density changes in neighboring regions. The highly nonlinear nature of stress constraints only exasperates the phenomenon in critical regions with large spatial stress gradients, such as reentrant corners, and the like. Accordingly, formulating design optimization problems and the algorithms for resolving the problems must be numerically consistent to avoid such convergence problems.

FIGS. 1A-1K illustrate various topology optimization methods which currently exist and may be used to provide optimized solutions for structures comprised of homogeneous isotropic materials. For example, FIG. 1A illustrates the initial problem definition to be resolved, which includes an L-bracket 2 that is fixed at a top edge 4, and subjected to a vertical transverse tip load 6 at the rightmost vertical edge 8. FIGS. 1B-1K illustrate the different solutions or structural designs that may be produced when performing the topology optimization methods listed in the table of FIG. 2. The table of FIG. 2 additionally summarizes the critical aspects that are used to obtain each solution or design, namely the length scale control, the material model used in, the finite element analysis, the relaxed stress used to define the stress constraint, the problem statement, the associated nonlinear programming algorithm, as well as any extraneous notes.

As shown in FIGS. 1A-1K, the initial design consists of a uniform material distribution, and thus, includes the reentrant corner as well as the stress singularity associated therewith. For reference purposes, a minimum compliance design subject to a volume constraint is also provided along with a plot of its stress contour. Each stress plot uses color scales with nine equal range levels. The reentrant corner is not removed in the compliance design. The designs of FIGS. 1D, 1E, 1H, 1I and 1K have reentrant corners, which are in fact similar to the compliance design of FIG. 1B. The reentrant corner is removed in the designs of FIGS. 1F, 1G and 1J.

In the designs shown, the design of FIG. 1F is obtained via an integer programming method which is not viable for large scale applications. The designs of FIGS. 1F and 1H do not contain length scale control but rather checkerboard control, and hence, their problem formulations are most likely ill-posed. The design of FIG. 1J undesirably contains excessively large regions of gray material. Among the designs shown in FIGS. 1A-1K, the approach in the design of FIG. 1G may appear the most promising. However, the design of FIG. 1G requires significant tuning of parameters which can heavily influence the final topology, and further, entail significant computational expenses which outweigh the benefits of solving the problem definition in question.

In sum, currently existing topology optimization methods substantially rely upon either local stress measurements or global stress measurements. While the local stress measurement approach provides precise control of a stress field, it is prohibitively expensive to employ in practical applications. Furthermore, while the global stress measurement approach is more computationally efficient, its control of the stress field is not as precise, resulting in designs that are less than optimal and in violation of stress constraints. Therefore, there is a need for an improved stress-based topology optimization system and method which overcomes the deficiencies associated with the presently available methods to provide computationally efficient designs as well as precise local control of associated stress fields.

### SUMMARY OF THE DISCLOSURE

In one aspect of the present disclosure, a method for performing stress-based topology optimization of a structure on a computational device is provided. The method may include the steps of receiving first data at an input device coupled to an input of the computational device, the first data pertaining to a problem definition of the structure; generating a density filter; generating interpolation schemes for stiffness, volume and stress; generating a global stress measure; generating an adaptive normalization scheme; generating a regional stress measure; generating second data based on the first data, the density filter, the interpolation schemes, the global stress measure, the adaptive normalization scheme and the regional stress measure, the second data pertaining to an optimized solution to the problem definition; and displaying the optimized solution at an output device coupled to an output of the computational device.

In another aspect of the present disclosure, a system for performing stress-based topology optimization of a structure is provided. The system may include an input device, an output device and a computational device. The computational device may include a microprocessor and a memory for storing an algorithm for performing stress-based topology optimization. The algorithm may configure the computational device to receive first data at the input device, the first data pertaining to a problem definition of the structure, generate a density filter, generate interpolation schemes for stiffness, volume and stress, generate a global stress measure, generate an adaptive normalization scheme, generate a regional stress measure, generate second data based on the first data, the density filter, the interpolation schemes, the global stress measure, the adaptive normalization scheme and the regional stress measure, the second data pertaining to an optimized solution to the problem definition, and output the second data to the output device.

In yet another aspect of the present disclosure, a computer program product is provided. The computer program may include a computer-readable medium with control logic stored therein for configuring a computer to perform stress-based topology optimization. The control logic may include a series of readable program code. The program code may configure the computer to generate a density filter; generate interpolation schemes for stiffness, volume and stress; generate a global stress measure; generate an adaptive normalization scheme; and generate a regional stress measure.

### BRIEF DESCRIPTION OF THE DRAWINGS

FIGS. 1A-1K are pictorial views of a problem definition and solution designs according to prior art topology optimization methods;

FIG. 2 is a table of prior art topology optimization methods;

FIG. 3 is a flow chart of an exemplary stress-based topology optimization method constructed in accordance with the teachings of the present disclosure;

FIG. 4 is a graphical view of various interpolation functions;

FIGS. 5A-5E are pictorial views of another problem definition and solution designs according to an exemplary normalization scheme;

FIGS. 6A-6B are graphical views of normalized volume and stress convergence;

FIGS. 7A-7B are pictorial views illustrating the evolution per iteration of a design according to a normalized global stress measure;

FIGS. 8A-8E are pictorial views of designs according to varying numbers of stress constraints;

FIGS. 9A-9B are pictorial views of additional problem definitions and associated solution designs according to the present disclosure; and

FIG. 10 is a schematic view of an exemplary stress-based topology optimization system constructed in accordance with the teachings of the present disclosure.

### DETAILED DESCRIPTION

Referring to the drawings and with particular reference to FIG. 3, an exemplary method for performing stress-based topology optimization is provided and referred to as reference number 10. It is understood that the teachings of the disclosure may be used to construct stress-based topology optimization techniques above and beyond those specifically disclosed below. One of ordinary skill in the art will readily understand that the following are only exemplary embodiments.

Turning to FIG. 3, an exemplary method 10 for performing stress-based topology optimization is provided. The method 10 may include a step 12 of generating a density filter for length scale control, a step 14 of generating interpolation schemes for stiffness, volume and stress, a step 16 of generating a global stress measure, a step 18 of generating an adaptive normalization scheme to precisely control the local stress level and a step 20 of generating a regional stress measure.

The density filtering technique of step 12 may be used to generate a well-posed topology optimization problem to be resolved. According to one technique, the design field d may be filtered to define the material density field ρ. Using piecewise uniform finite element discretization of density, the vectors d and ρ may include the element design variables and densities, respectively. The latter may be defined by filtering the former. For example, the filter may be defined by

$${ρ}_{i} = \frac{{\sum }_{j ∈ Ω i} {w}_{j} {d}_{j}}{{\sum }_{j ∈ Ω i} {w}_{j}} with {w}_{j} = \frac{{r}_{o} - {r}_{j}}{{r}_{o}} \qquad ( 1 )$$

where the domain Ωᵢ of element i contains all elements j that lie within the radius rₒ of element i as measured from their respective centroids. The weighting factor wⱼ>0, as defined in expressions (1) above, may correspond to that of a cone filter where rⱼ may be the distance between the element i and j centroids. Alternative smoothing filters may also be used.

As generally applied to topology optimization problems, the density ρ may be bounded between 0 and 1. Similar bounds may be imposed on d, and thus, by defining ρ via the filter, an upper bound value for |∇ρ| may be determined where ∇ρ may be the spatial gradient of ρ. By defining ρ through the bounded d, smoothness may be imposed on ρ without requiring any additional constraints on d. Such smoothness may serve to prevent designs with small scale features, such as narrow members, jagged edges, micro-perforations, sharp interfaces, or the like.

Density-based topology optimization may be used to generate black and white designs from which structural members may be readily identified. However, the generation of black and white designs that exhibit small scale features, for example, jagged edges, at early intermediate iterations may not be so useful for the purposes of stress-based topology optimization. Stress may be a local measure which exhibits high spatial gradients. The spatial gradients may be determined from the displacement gradient. However, the displacement gradient may be determined with less accuracy than the finite element displacement field, especially in stress concentration regions. The resulting stress computed at element centroids may be artificially low with respect to the small scale features, for example, jagged edges, which are known to include stress singularities. Small scale features, such as jagged edges, may ultimately be smoothed in the design interpretation stages when the computed stress levels increase. Accordingly, it may be more effective to generate designs with smooth blurred boundaries using a filter, for example, the filter defined by expressions (1) above, than to generate designs having sharp jagged boundaries.

Still referring to FIG. 3, the method 10 for performing stress-based topology optimization may further include a step 14 for generating interpolation schemes for stiffness, volume and stress. In one such application, the method 10 may generate a solid isotropic material with penalization (SIMP) model to provide black and white designs, while further generating a stress relaxation definition to resolve the stress singularity phenomenon. Filter-induced blurred regions around structural members may facilitate the evolution of a design towards the global optima by allowing void elements to be represented as solid elements and vice-versa. The SIMP model may be what penalizes intermediate densities and generate black and white designs which may force the optimization to prematurely converge to local optimal. Accordingly, the filter may provide smoothing for the optimization algorithm, and further, enhance its ability to converge to the global optima. In such a way, the SIMP model may be one of many interpolation schemes provided in step 14 to effectively complement the density filter provided in step 12.

In certain applications, the stress-based topology optimization method 10 may further generate a stress relaxation definition, for example, a SIMP-like relaxed stress definition, for solving singularities. A singularity problem may exist when optimal topologies belong to degenerate subspaces of a feasible design space where one or more bars have zero cross section. Convergence to such optimal topologies, or singular topologies, is essentially impossible with gradient-based optimizers. One way to eliminate such degenerate subspaces may be to relax the stress constraints by using, for example, the e-relaxation and smooth envelope functions (SEFs) and related variations that are adapted for use with continuum design. Introducing such relaxation may make the topology optimization problem more tractable by generating a smooth feasible design space.

When stress constraints are relaxed, and when a SIMP technique is applied, black and white structures may be designed with homogeneous isotropic material properties that satisfy stress constraints. Although intermediate density material may exist for intermediate density values, such materials may be deemed irrelevant as only black and white designs are ultimately considered. Nonetheless, the SIMP technique may also be used to model porous microstructures indicative of materials with intermediate density values.

To relax stress constraints, a SIMP-like relaxed stress definition may be employed. More specifically, the discrete topology optimization problem, for example, where ρε{0, 1}, may be relaxed to a continuous optimization problem, for example, where ρε[0, 1], which may be forced to generate a discrete design at the end of the optimization process. Consequently, interpolation schemes for the stiffness, volume, stress, and the like, may be defined so as to interpolate between respective possible minimum and maximum values. For stiffness, value η_{c} may be introduced to weight the solid material elasticity tensor ₒ, as defined for example by

[symbol]

(ρ)=η_{c}(ρ)ₒ (2)

where η_{c}, is a monotonically increasing function, within the range of 0<η_{c}(ρ)≦ρ for 0<p<1, satisfies η_{c}(1)=1 and also satisfies η_{c}(0)=0. For volume, value ηᵥ may be introduced to weight the infinitesimal volume dυₒ as

dυ=η_{υ}(ρ)dκₒ (3)

where the total volume may be determined by V=∫_{Ω}η_{υ}(ρ) dυₒ, and where ηᵥ is a monotonically increasing function, within the range of 0≦ηᵥ(ρ)<1 for 0<ρ<1, satisfies ηᵥ(1)=1 and also satisfies ηᵥ(0)=0. The interpolation of stiffness and volume may essentially be responsible for the penalization of intermediate densities so as to force the final design to be discrete. For example, the interpolations corresponding to the SIMP techniques may be η_{c}(ρ)=ρ^{p} and ηᵥ(ρ)=ρ whereby the stiffness may be penalized for intermediate densities. Alternatively, the volume, or both the stiffness and the volume, may be penalized according to the sinh technique, or other comparable techniques well known in the art.

Similarly, value η_{T} may be introduced to weight the stress in the solid material, for example, Tₒ≡ₒ[∇u], as defined by

Tᵣ(ρ)=ηT(ρ)Tₒ (4)

where η_{T} is a monotonically increasing function, within the range of η_{c}(ρ)<η_{T}(ρ)<1 for 0<ρ<1, satisfies η_{T}(0)=0 so that the stress in void regions is zero and the feasible design space is smooth without degenerate regions, and further, where η_{T} in satisfies η_{T}(1)=1 so that the relaxed stress is consistent with stress in the solid material. In alternative embodiments, η_{T} may be selected to satisfy ρ<η_{T}(ρ) such that intermediate densities are further penalized by the stress interpolation.

The bounds on η_{T}, wherein η_{c}(ρ)<η_{T}(ρ)<1 for 0<ρ<1, may suggest that the interpolated stress is chosen between two limiting stresses, including solid stress defined by, for example, Tₒ≡ [symbol] [∇u], and macroscopic stress defined by, for example, T(ρ)≡ [symbol] (ρ)[∇u]=η_{c}(ρ) Tₒ. Both solid and macroscopic stresses may not suitable for use in stress-based topology optimization. With respect to solid stress, stress at zero densities may be non-zero since the strain ∇u may typically be non-zero. As a result, the optimizer may be unable to eliminate materials in some areas of the design domain. In contrast, with respect to macroscopic stress, the optimizer may generate a trivial all-void design. This may be demonstrated by considering a feasible design ρ which may have an elasticity tensor that is defined by, for example, [symbol] (ρ)=η_{c}(ρ) [symbol] where value η_{c}(ρ) may be a homogeneous function of degree p>1, for example, where η_{c}(ρ)=ρ^{P}, and a displacement of u (ρ). Subsequently, the feasible design ρ may be uniformly scaled such that ρ→αρ where 0<α<1. For the scaled design, it may be determined that [symbol] (αρ)=(αρ) [symbol] =α^{P} η_{c}(ρ) [symbol] =α^{p} [symbol] (ρ), and further, that u (αρ)=α^{-P} u (ρ). Accordingly, further examination of the macroscopic stress may provide T(αρ)=T(ρ). Uniformly eliminating macroscopic materials may not affect the stress, and thus, the optimization may attempt to eliminate all materials.

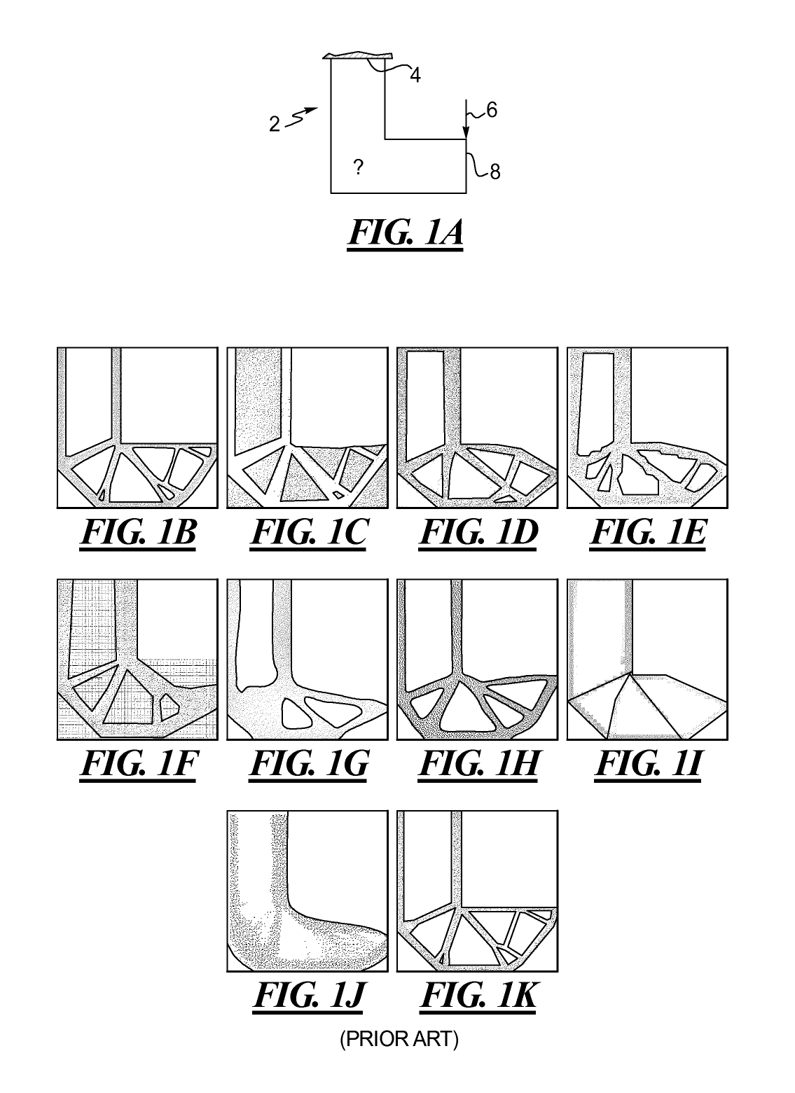

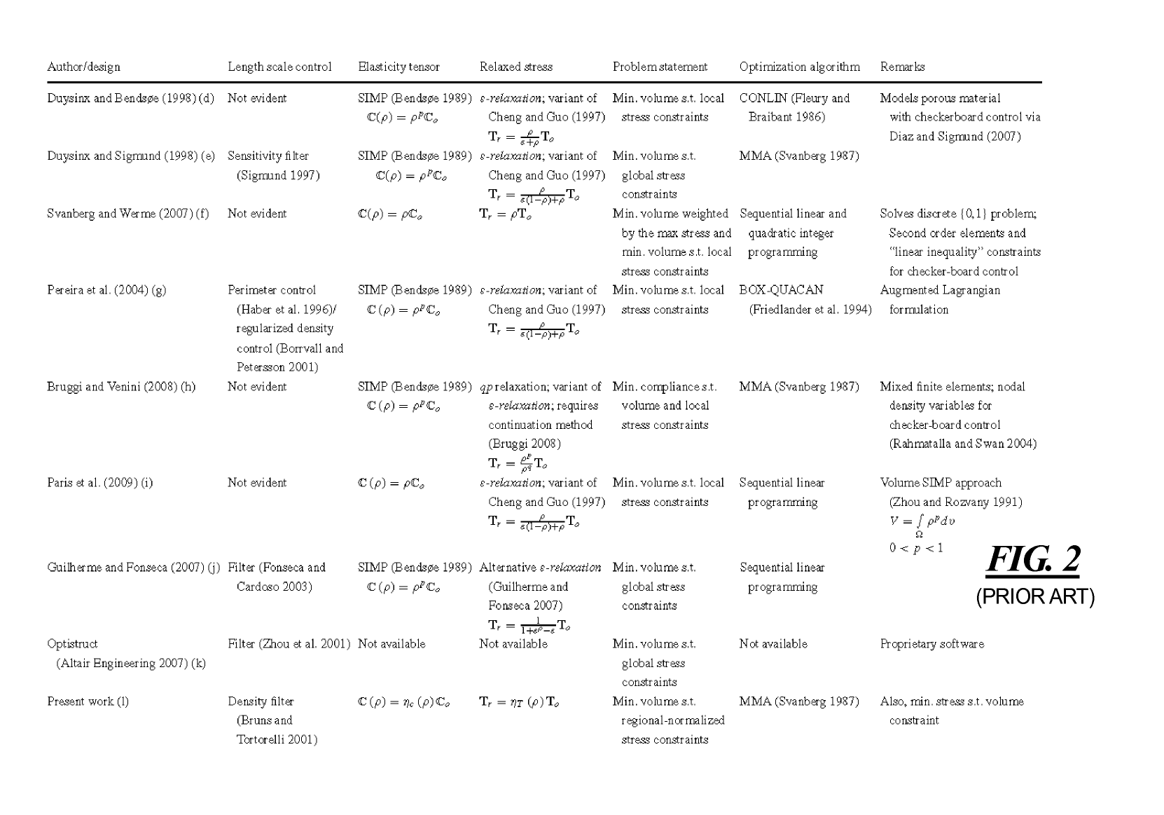

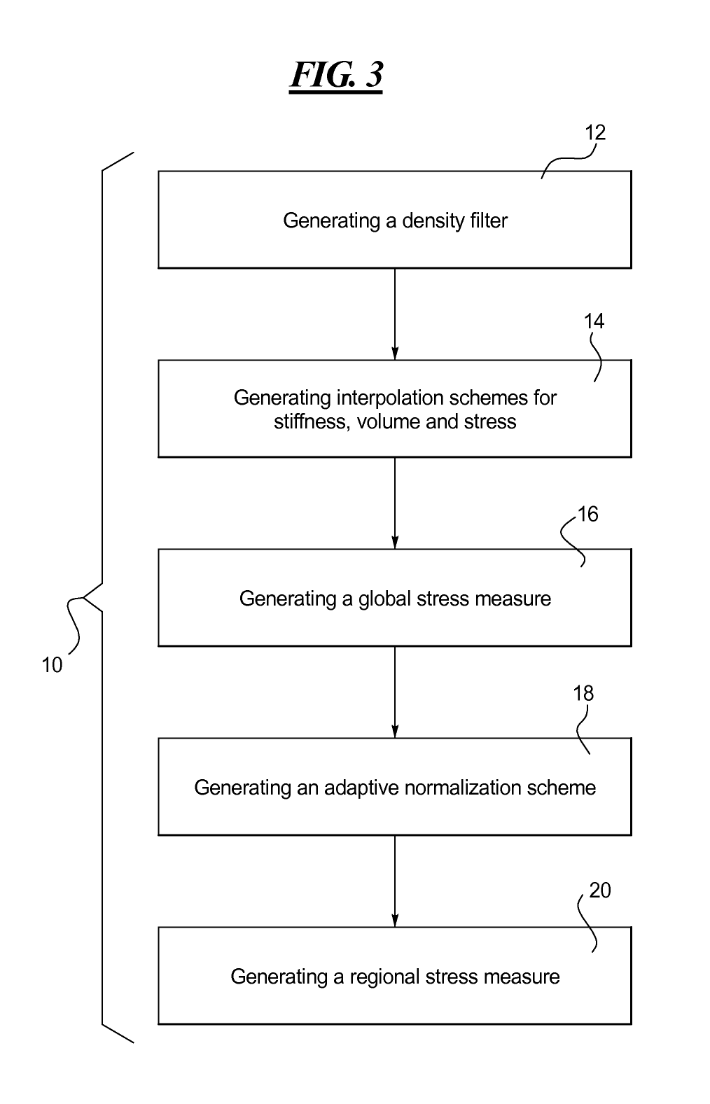

The relaxed stress Tᵣ of expression (4) may be used to define the stress measure σ, which in turn may be used to define either the stress constraints or the objective function. Additionally, the ultimate η_{T} enforced via continuation may lead to functions which approximate the step function with nearly zero sensitivity for a fixed strain, and further, adversely affect the optimization convergence. Moreover, the selection of the values for η_{c}, ηᵥ and η_{T} may be flexible. Applying various well known interpolation schemes to the L-bracket 2 example of FIG. 1 may provide the following expressions

$$\begin{matrix}1 ) \begin{matrix}{η}_{c} = {ρ}^{3} \\ {η}_{v} = ρ \\ {η}_{T} = {ρ}^{1 / 2} ,\end{matrix} \\ 2 ) \begin{matrix}{η}_{c} = ρ \\ {η}_{v} = {ρ}^{1 / 3} \\ {η}_{T} = {ρ}^{1 / 6} ,\end{matrix} \\ 3 ) \begin{matrix}{η}_{c} = {ρ}^{3} \\ {η}_{v} = ρ \\ {η}_{T} = 1 - \frac{sinh [ 3 ( 1 - ρ ) ]}{sinh ( 3 )}\end{matrix} \\ and \\ 4 ) \begin{matrix}{η}_{c} = {ρ}^{3} \\ {η}_{v} = ρ \\ {η}_{T} = \frac{ρ}{0.3 ( 1 - ρ ) + ρ}\end{matrix}\end{matrix} \qquad ( 5 )$$

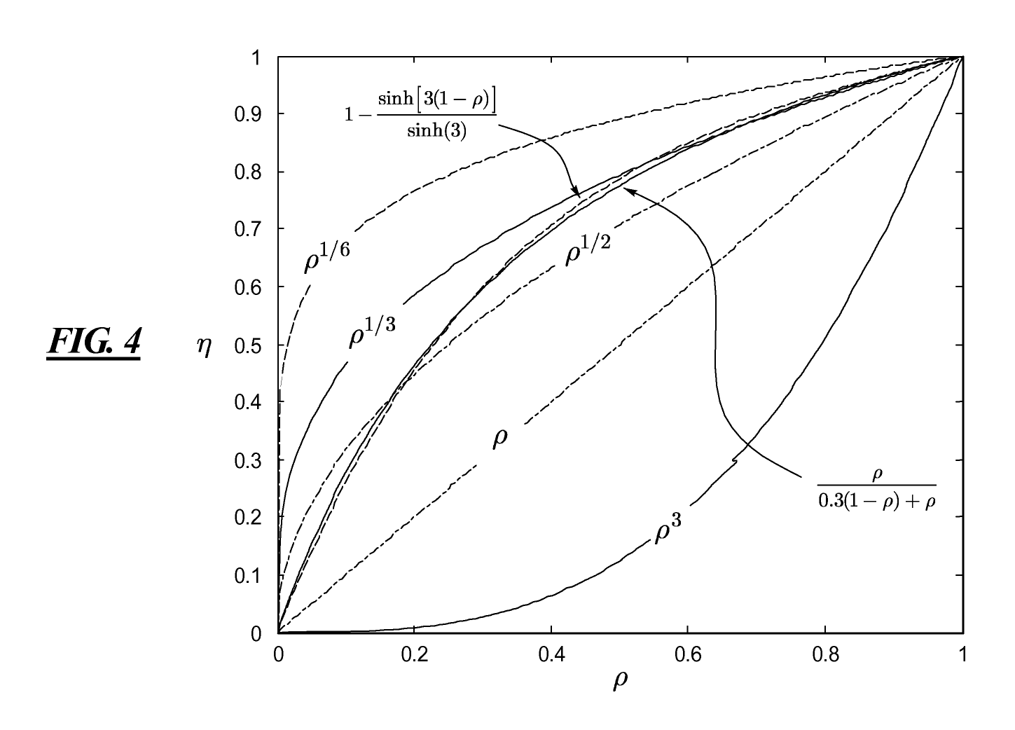

The respective functions of the four exemplary interpolation schemes in the above expressions (5) may be plotted as shown in the graph of FIG. 4. While any other comparable interpolation scheme may be employed, the first listed scheme in the above set of equations (5) may be used for further analyses.

The method 10 of FIG. 3 may further include a step 16 of generating a global stress measure. In finite, element-based, stress-constrained topology optimization problems, one stress constraint may be typically enforced per finite element. This may suggest that the number of stress constraints n may be substantially large. Furthermore, as the number of design variables may be equal to the number of elements, the number of design variables n may also be large. Therefore, sensitivity computation, by either the direct or adjoint techniques, may prohibitively be costly. In particular, as the number of pseudo analyses in the direct technique and the number of adjoint analyses in the adjoint technique may equal n, it follows that both methods may be equally costly. To reduce the computational burden, a single global stress measure may be used in place of the n individual local stress measures, thereby making the adjoint sensitivity analysis computationally more efficient and easier to manage.

The global stress measure of step 16 may be defined by referring back to the original problem having n constraints, one for each element e, for example,

σₑ≦ σ̅, e=1, 2, . . . (6)

where σ≡\hat{σ}(Tᵣ) may be the relaxed stress measure, σ̅ may represent the respective bound, and e may be the element index. The n constraints may further be restated in terms of the single maximum stress constraint, for example,

$${σ}_{max} ( ρ ) = {max}_{e = 1 … n} ( {σ}_{e} ( ρ ) ) \leq \overline{σ} \qquad ( 7 )$$

However, the maximum function may not be differentiable, and thus, may need to be smoothed by using, for example, p-norm or the Kreisselmeier-Steinhauser (KS) function. By adopting the p-norm measure σ_{P N}, the constraint may become

$${σ}_{PN} = {( {\sum }_{e = 1}^{N} {v}_{e} {σ}_{e}^{P} )}^{1 / P} \leq {\overline{σ}}_{PN} \qquad ( 8 )$$

where P may be the stress norm parameter and υₑ may be the element e solid volume. Accordingly, a single stress criterion may be imposed on the structure and the stress measure σₑ may be non-negative.

Based on expression (8), it may be determined that as the stress norm parameter P→∞, the p-norm σ_{P N} may approach the maximum stress σₘₐₓ, modulo the element volume, in which case there may be no added smoothness. It may also be determined that when P→1, there may be excessive smoothness but the p-norm may approach the average stress, modulo the volume. A good choice for P may therefore provide adequate smoothness so that the optimization algorithm performs well and provides adequate approximation of the maximum stress value. This is so that the optimized design may better satisfy the imposed stress constraints.

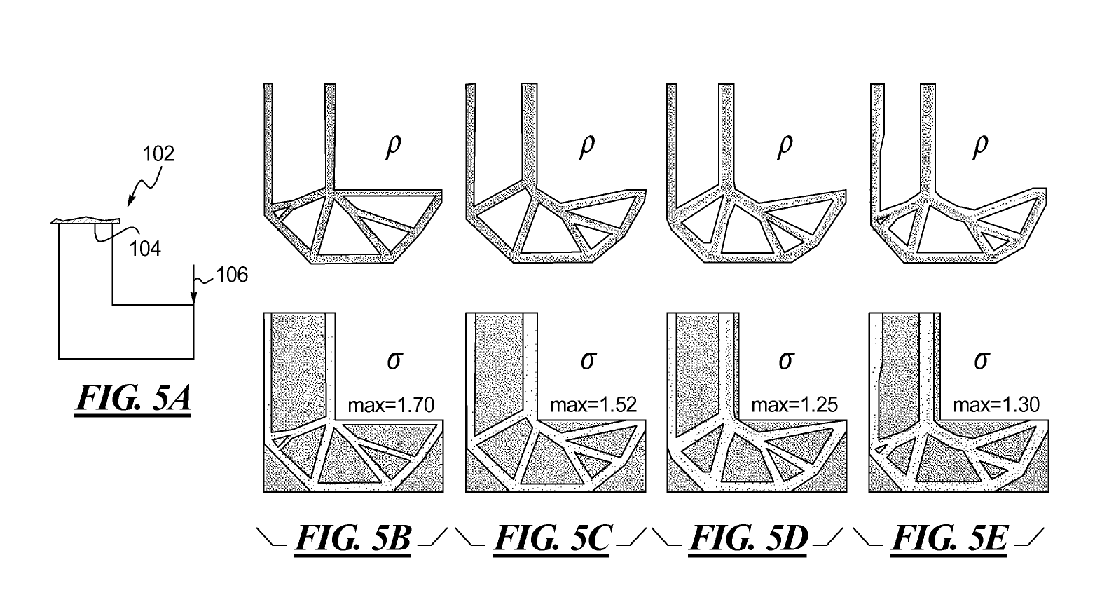

For stress minimization formulations the choice of the stress norm parameter P may not be critical because the p-norm may only need to capture the trend of the maximum stress and not the actual maximum stress value. This may be demonstrated with an exemplary problem definition, for example, the L-bracket 102 of the problem definition of FIG. 5A. As shown, the problem definition may indicate dimensions of the L-bracket 102 as including a maximum height of 100 mm, a maximum width of 100 mm and a thickness of 40 mm. As with the L-bracket 2 of FIG. 1A, the L-bracket 102 may be fixed at a top edge 104 thereof and subjected to a vertical transverse tip load 106.

The problem may be formulated to minimize stress σ_{P N}, as defined for example in expression (8) above, where σₑ may be the stress at the element centroids, subject to the volume constraint V≦V≦Vₘₐₓ where Vₘₐₓ may be the design domain volume, and further, may be solved with any gradient-based optimization algorithm, or the like. The finite element analysis may employ bilinear 4-node square elements with a thickness of 1.0 mm and edge length of 1.0 mm. The represented material may have a Young's modulus of E=1.0 MPa and a Poison's ratio of υ=0.3. The cone filter radius may be rᵢ=2.0 mm, in accordance with, for example, expressions (1). Furthermore, the 3 N load may be distributed over six nodes to avoid a stress concentration. The designs and the respective stress distribution plots of FIGS. 5B-5E may illustrate the results that are obtained using the stress norm parameter values P=4, 6, 8 and 12. As shown, lower P values may result in designs similar to that of the compliance minimization, which may have a stress concentration at the reentrant corner. In contrast, larger P values may result in designs with more uniform stress distributions in which the stress concentration may be reduced. The designs of FIGS. 5B-5E may also indicate that the optimization with P=12 involves more iterations and is more susceptible to local minima in comparison to the optimization with lower P values. For the particular stress minimization example of FIGS. 5A-5E, it can be seen that the values of P=6 and 8 may yield best designs. Notably, the number of iterations required to obtain the designs of FIGS. 5B-5E may be comparable to the number of iterations required for the compliance problem.

The method 10 of FIG. 3 may also include a step 18 of generating an adaptive normalization scheme. The p-norm stress measure σ_{P N} from expression (8) above may lack physical meaning as opposed to, for example, the maximum stress σₘₐₓ. In fact, an explicit mathematical expression of σₘₐₓ in terms of σ_{P N} may not exist. It follows that the ability to enforce a constraint on the maximum stress using the p-norm stress σ_{P N} may also be lacking. Providing a normalized global stress measure may provide a better approximation of the maximum stress. Moreover, the normalized global stress measure may incorporate information from the previous optimization iteration to scale, or normalize, the global p-norm measure as c σ_{P N} so that it better approximates the maximum stress. To define the normalization parameter c, the maximum stress σₘₐₓ^{I-1} and the p-norm σ_{P N}^{I-1} values from the previous optimization iteration I−1 may be used. The evolving normalized global p-norm constraint at each iteration I may then be defined as

σₘₐₓ≈cσ_{P N}≦ σ̅ (9)

where c may be calculated at each optimization iteration I≦1 as

$${c}^{I} = {α}^{I} \frac{{σ}_{max}^{I - 1}}{{σ}_{PN}^{I - 1}} + ( 1 - {α}^{I} ) {c}^{I - 1} \qquad ( 10 )$$

The above parameter α^{I}ε(0, 1] may control the variations between c^{I} and c^{I-1}. If c tends to oscillate between iterations, α^{I} may be chosen from 0<α^{I}<1. If c does not oscillate between iterations, α^{I} may be chosen as 1. Here, α^{I} may be selected as 1. As the design converges, d^{I}≈d^{I-1} so that σ_{P N}^{I}≈σ_{P N}^{I-1} and σₘₐₓ^{I}≈σₘₐₓ^{I-1}. This may be in accordance with the desired relationship of expression (9) above, for example, c^{I} σ_{P N}^{I}σₘₐₓ^{I}. Because the value of c may be changed in a discontinuous manner, the constraint cσ_{P N}≦ σ̅ may be non-differentiable and the resulting optimization problem may be slightly different for each iteration. However, as the optimization converges, the changes between successive design iterations may diminish and the corresponding value of c may converge, thereby reducing the effects of non-differentiability and inconsistency.

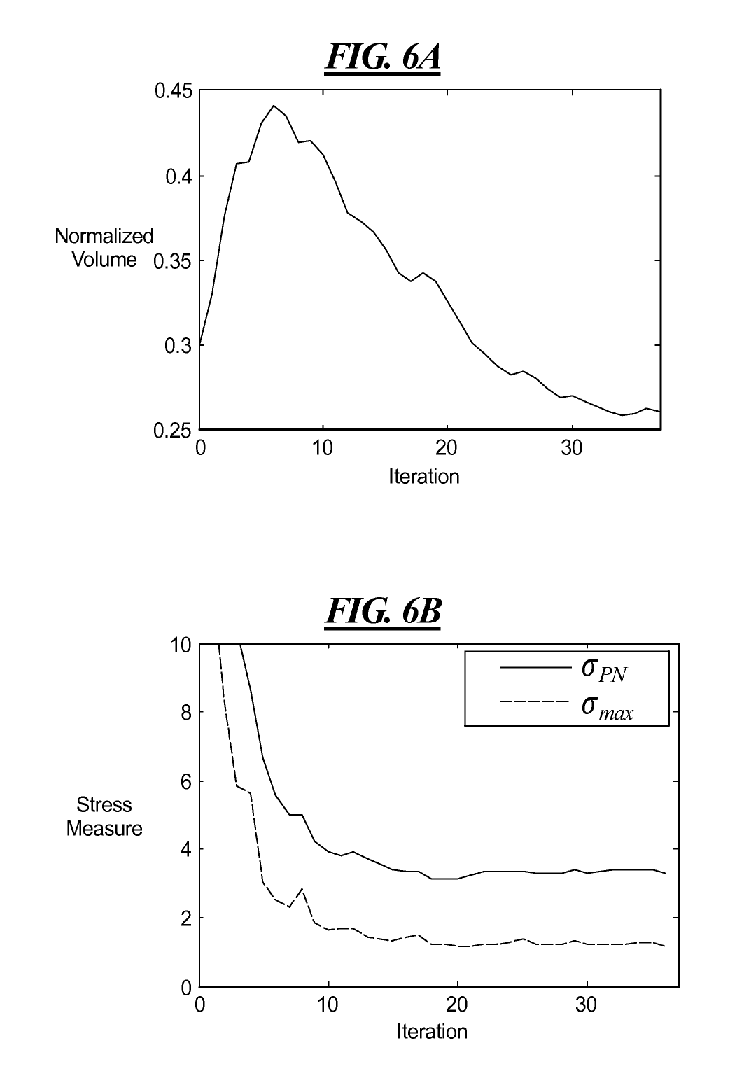

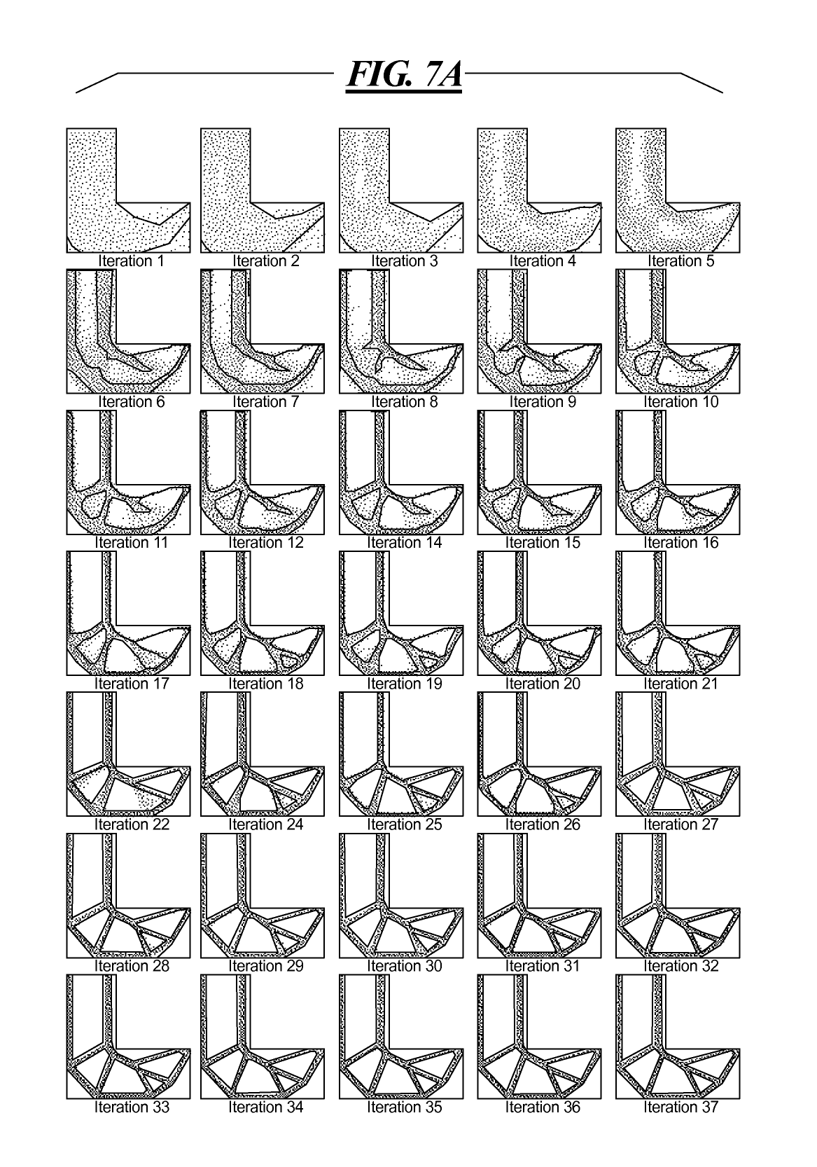

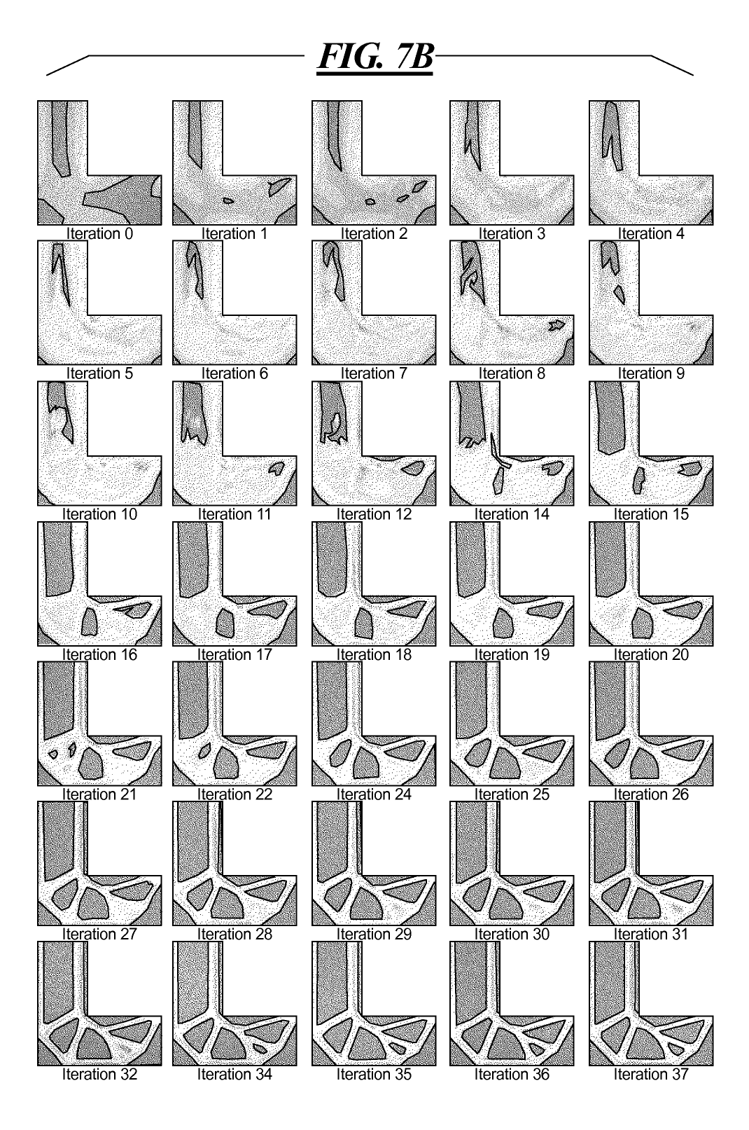

The normalization scheme may be demonstrated as applied to the L-bracket 102 of FIG. 5A. For this application, the volume subject to a maximum elemental stress of 1.2 MPa may be minimized, for example, cσ_{P N}≦ σ̅=1.2, while the stress norm parameter may be P=6. The corresponding normalized volume and stress convergence plots may be illustrated, as shown for example in FIGS. 6A and 6B, respectively. From the convergence graphs of FIGS. 6A and 6B, it can be seen that the maximum stress constraint may be active in the optimal design. Furthermore, the designs of FIG. 7A may illustrate the evolution of density ρ, while the designs of FIG. 7B may illustrate the evolution of stress σ during the normalization of the global stress measure.

Each of the steps 12, 14, 16 and 18 of the optimization method 10 of FIG. 3 may rely upon either a local or a global stress measure to resolve stress-constrained problems. Imposing local stress constraints may provide more precise control over local stress levels, but it may also require a prohibitively large computational expense. In contrast, using a single global stress measure may relieve the large computational expense, but it may provide poor local control over the stress distribution. In order to compensate for the drawbacks associated with both extremes, the method 10 of FIG. 3 may additionally include a step 20 of generating regional stress measures. More specifically, applying several regional stress measures may improve the local control while maintaining manageable computational costs. Rather than using the n constraints of expression (6) or the single global constraint of expression (9), m regional constraints may be enforced using, for example,

$${σ}_{{max}_{k}} = {max}_{e ∈ {Ω}_{k}} ( {σ}_{e} ) \leq \overline{σ} , k = 1 , 2 , … , m \qquad ( 11 )$$

where Ωₖ may represent the set of elements in region k of a body region Ω. In such a way, the normalized p-norm constraint of expression (9) may be imposed over each region k using, for example,

σₘₐₓ_{ₖ}≈cₖσ_{P N}_{ₖ}≦ σ̅, k=1, 2, . . . (12)

where cₖ may be determined independently for each region using expression (10) and where σ_{P N}_{ₖ} may be obtained from expression (8) by considering only the elements in region Ωₖ.

Each region may be defined and based on any combination of attributes, including, but not limited to, physical location, stress distribution, element connectivity, and the like. In some cases, the regions may also be interlaced to generate better results. Defining regions in such a way may serve to provide better control of local stress. The individual regions need not be connected, or the elements that make up each region need not be contiguous. To define the interlacing regions, elements may be sorted based on respective stress levels at the current design iteration I, according to, for example,

{e₁, e₂, . . . , eₙ; σₑ_{₁}^{I}≦σₑ_{₂}^{I}≦ . . . ≦σₑ_{ₙ}^{I}} (13)

and then define the m regions using, for example,

Ωₖ≡{eₖ, eₘ₊ₖ, e₂ₘ₊ₖ, . . . }, k=1, 2, . . . , m (14)

When the values of m=1 and m=n, where n represents the number of elements, constraints may be defined according to expressions (6) and (9).

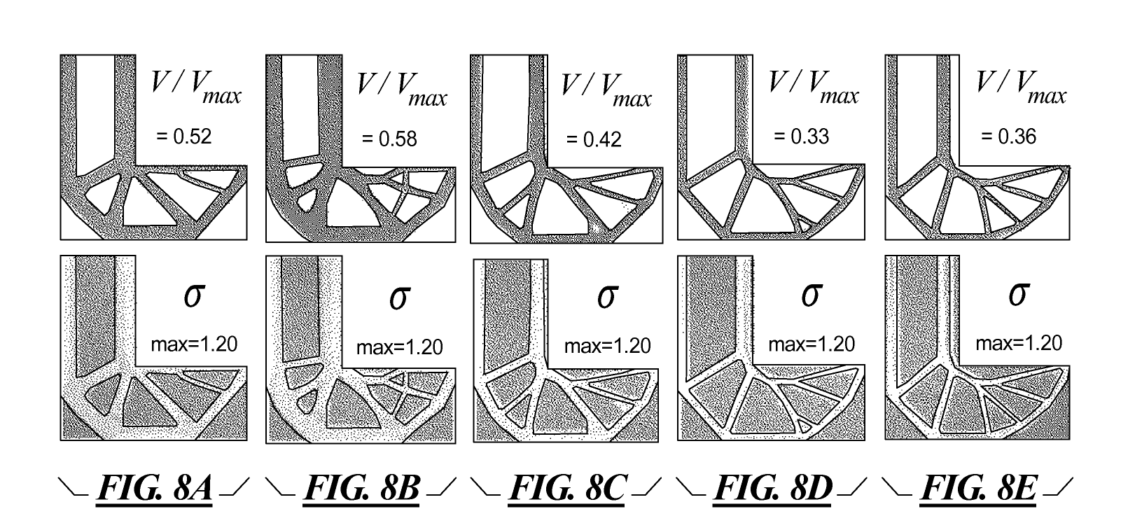

Referring now to FIGS. 8A-8E, exemplary density and stress designs of the L-bracket 102 of FIG. 5A are provided using a stress norm parameter P=4 and progressively increasing numbers of regions m. Specifically, the optimized solutions or designs of FIGS. 8A-8E may correspond to m=1, 2, 4, 8 and 16 regions, respectively. As illustrated, the number of regions m may have an effect on the stress-constrained problem, whereby the designs may improve as the number of regions increases. For instance, the design of FIG. 8A corresponding to m=1 region may be unsatisfactory because a stress concentration may exist at the reentrant corner that is not removed. In FIG. 8D where m=8, the stress concentration may effectively be removed and the stress distribution may become essentially uniform. In all designs, the maximum stress limit of 1.2 MPa may be achieved via the normalization provided by step 18. Accordingly, using a modest m-fold increase in an already efficient adjoint sensitivity computation, it may be possible to significantly improve the designs. Furthermore, it may be possible to use a relatively modest stress norm parameter P=4 to provide a smooth design space that is easily traversed while performing, for instance, the topology optimization method 10 of FIG. 3.

The method 10 of FIG. 3 may also be readily extended to accommodate multiple local constraint types and multiple load cases. In some applications, it may be desirable to impose different stress constraints corresponding to different load cases, and possibly on different regions of a given structure. For instance, one load case may correspond to a very severe load for which a stress constraint on the entire structure may be related to the material's yield strength. Additionally, there may be a load case related to a repetitive, damaging load for which a stress constraint on the regions where the structure may be welded to its support may be related to the material's endurance limit. To accommodate for such instances, it may be possible to define the m regions Ωₖ accordingly. However, this may produce regional biases which may adversely affect the results. Therefore, the original constraint of expression (6) may then be redefined as, for example,

$$\frac{{σ}_{e}}{{\overline{σ}}_{e}} \leq 1 , e = 1 , 2 , … , n \qquad ( 15 )$$

As shown in expression (15) above, σₑ may be the respective local response, for example, it may represent either the element stress or the strain energy density values, and σ̅ₑ may represent its respective bound. To define the regions based on the interlacing scheme of expression (14), the elements may be sorted by the value of σₑ/ σ̅ₑ, and each regional constraint may be redefined as, for example,

$${{c}_{k} [ {\sum }_{e ∈ {Ω}_{k}} {{v}_{{o}_{e}} ( \frac{{σ}_{e}}{{\overline{σ}}_{e}} )}^{P} ]}^{1 / P} \leq 1 , k = 1 , 2 , … , m \qquad ( 16 )$$

based on expressions (8), (9) and (12). Here, the value of σₑ/ σ̅ₑ rather than the value of σₑ may be assumed to be non-negative. This technique may also be applied to stress minimization problems where σ̅ₑ may become scale factors and the cost function may be defined using expression (16) with m=1 region.

A typical way to address the multiple load case problem may be to consider each of the l load cases separately and use m regional constraints per load case. Alternatively, all load case l-element e stress ratios σₑ^{l}/ σ̅ₑ^{l} may be combined into a single set and subsequently divided into regions via an interlacing approach. Notably, the minimum number of constraints in the former approach may equal the number of load cases l, whereas the minimum number of constraints in the latter approach may simply equal 1. Accordingly, the latter approach may be used to define the cost function for a stress minimization problem.

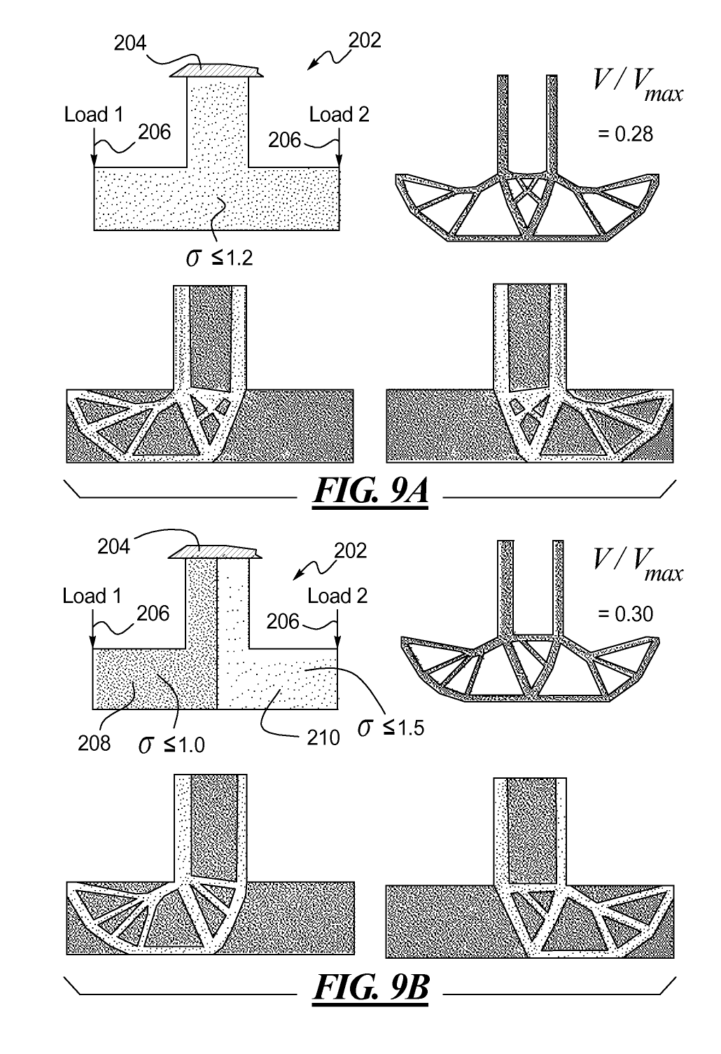

Turning now to FIGS. 9A and 9B, a design of another L-bracket 202 is provided that is similar to the L-bracket 102 of FIG. 5A with the exceptions to its geometry and loading. As with previous L-brackets 2, 102, the L-bracket 202 of FIGS. 9A and 9B may have a fixed top edge 204. Furthermore, each of the two load cases may be defined by the application of an equivalent concentrated load 206 at the respective ends. Two designs may be generated, including volume minimization subject to stress constraints with a single stress criterion, as shown for example in FIG. 9A where σ̅ₑ^{l}= σ̅=1.2 MPa, and volume minimization subject to stress constraints with elemental stress limits, for example, where σ̅ₑ=1.0 MPa in the first region 208 of FIG. 9B and σ̅ₑ=1.5 MPa in the second region 210 of FIG. 9B. The designs may be obtained using the stress norm parameter P=8 and m=1 regions. As shown in FIG. 9B, more material may be distributed to the weaker first region 208 to accommodate the lower stress limit. In both designs, the scaled stress, or σₑ^{l}/ σ̅ₑ, may tend to be uniform under the respective load. Convergence may be obtained after approximately 190 and 250 iterations. In such a way, multiple load case and multiple stress criterion problems may be solved without appreciably more computational effort than compliance problems.

Accordingly, for the stress-constrained problem, the volume may be minimized subject to stress constraints, for example,

$${min}_{{0 < d \leq 1}_{s . t .}} v ( p ) \\ {c}_{k} {σ}_{{PN}_{k}} = {[ {\sum }_{( ρ , l ) ∈ {Ω}_{k}} {{v}_{e} ( \frac{{σ}_{e}^{l}}{{\overline{σ}}_{e}^{l}} )}^{P} ]}^{1 / P} < 1 , k = 1 , 2 , … , m \qquad ( 17 )$$

where ρ may be the element density vector, which may be a function of the element design vector d, as defined in expression (1), where V may be the structure volume, which may be a function of ρ and d, where υₑ may be the element e solid volume, where σₑ^{l} may be the stress measure in element e under load case l, which may be an implicit function of ρ and d, where Ωₖ may be the set of element-load case stresses in region k, where σ̅ₑ^{l} may be the stress limit for element e under load case l, where cₖ may be the normalization factor for region k, as defined in expression (10), and where m may be the number of constraints, or the number of regions. Using the same notation, the stress minimization problem may be defined as, for example,

$${min}_{{0 < d \leq 1}_{s . t .}} {σ}_{PN} = {[ {\sum }_{( e , l ) ∈ {Ω}_{k}} {{v}_{e} ( \frac{{σ}_{e}^{l}}{{\overline{σ}}_{e}^{l}} )}^{P} ]}^{1 / P} \\ V ( p ) \leq \overline{V} \leq {V}_{max} \qquad ( 18 )$$

where V̅ may be the volume limit, where Vₘₐₓ may be the design domain volume, and where σ̅ₑ^{l} may be interpreted as a scale factor. For completeness and for comparison purposes, the compliance minimization problem may be defined as, for example,

$${min}_{{0 < d \leq 1}_{s . t .}} U = {\int }_{Ω} ∇ u \cdot C [ ∇ u ] d v \\ V \leq \overline{V} \leq {V}_{max} \qquad ( 19 )$$

where [symbol] =η_{c}(ρ) [symbol] . In expressions (17), (18) and (19) above, the elasticity equations may define additional constraints that relate the stress values to the design d. The sensitivities for these implicitly defined relations may be obtained via the adjoint technique, or the like.

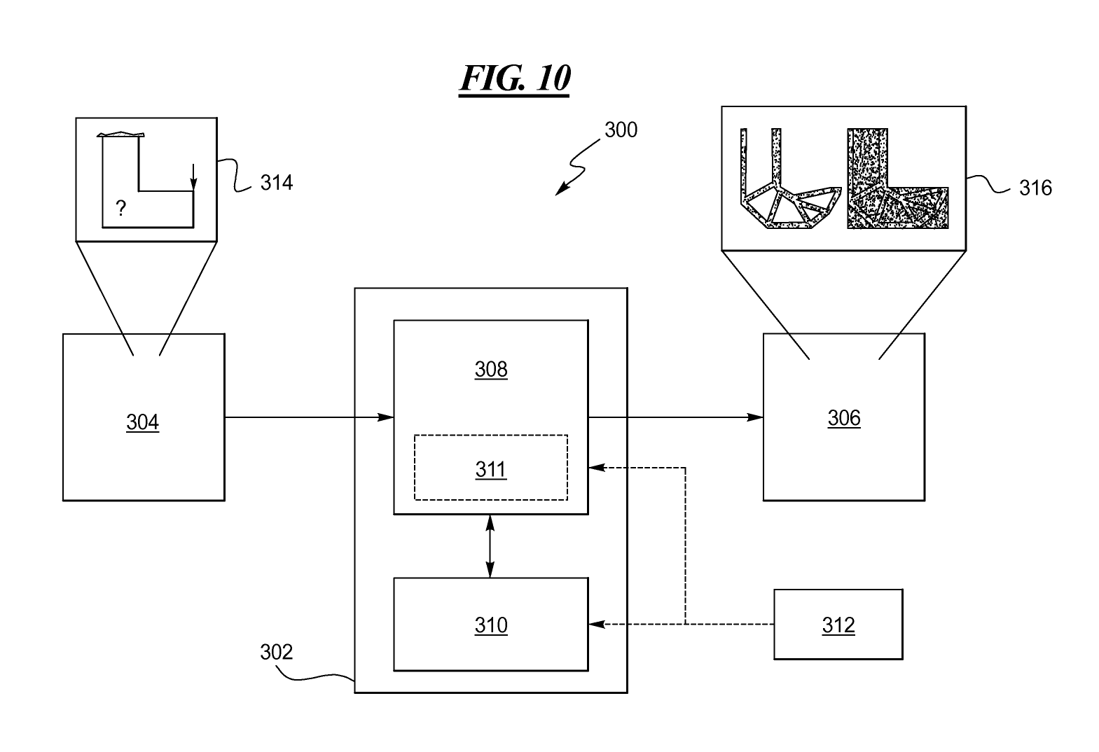

Turning now to FIG. 10, an exemplary system 300 for optimizing stress-based topologies of a given structure is provided. The system 300 may include a computer or computational device 302, an input device 304 and an output device 306. The computational device 302 may include a microprocessor 308 and a memory 310. The algorithm for performing stress-based topology optimization, for example, the method 10 of FIG. 3, may be stored or installed on the memory 310 of the computational device 302 so as to be readily accessible by the microprocessor 308. Alternatively, the microprocessor 308 may include on-board memory 311 similarly capable of storing the algorithm and allowing the microprocessor 308 access thereto. The algorithm may also be provided on a removable computer-readable medium 312 in the form of a computer program product. Specifically, the algorithm may be stored on the removable medium 312 as control logic or a set of program codes which configure the computational device 302 to perform according to the algorithm. The removable medium 312 may be provided as, for example, a compact disc (CD), a floppy, a removable hard drive, a universal serial bus (USB) drive, or any other computer-readable removable storage device. Upon inserting or electronically coupling the removable medium 312 to the microprocessor 308, the microprocessor 308 may be enabled to access the algorithm stored thereon. Furthermore, the input device 304 may include one or more of a mouse, keyboard, touchpad, touch-screen display, or the like. The output device 306 may be implemented as a monitor, printer, or the like.

During operation, the input device 304 may be configured to receive a problem definition that may be specified by a user, such as those shown in FIGS. 1A and 5A. More specifically, a user may input into the input device 304 information or first data 314 pertaining to the problem definition to be resolved including, for example, geometries or dimensions of a given structure, material of the given structure, stress criteria, load data, and the like. From the input device 304, the problem definition or first data 314 may be transmitted to the computational device 302. In some embodiments, the first data 314 may also be temporarily stored within the memory 310 for retrieval by the microprocessor 308. The computational device 302 may then proceed to convert the problem definition data 314 into a second data or solution data 316 in accordance with the algorithm. Moreover, in response to the received first data 314, the microprocessor 308 may access the algorithm from any one of the storage devices 310, 311 and 312, to begin generating an optimized solution to the problem defined by the user according to the stress-based topology optimization method 10 of FIG. 3. Once the solution data 316 has been determined, the microprocessor 308 may be enabled to render the optimized solution as, for example, structural design images representing density and/or stress distributions. The microprocessor 308 may then be enabled to transmit the solution data 316 and the associated rendered images to the output device 306 to be displayed or presented to the user.

### INDUSTRIAL APPLICABILITY

The foregoing disclosure finds utility in any structural design application that may demand more accurate characterization of a concept structure before reducing the structure to tangible builds and actual strength and/or durability testing. In the construction industry, for example, the disclosed stress-based topology optimization method 10 may be used to conceptualize the structural characteristics of a novel work tool of a construction vehicle so as to better predict the optimum design for the novel work tool. This can significantly reduce the time and costs associated with repeatedly building a number of work tools with slightly modified designs and subjecting the work tools to strength tests.

What is claimed is:

1. A method for performing stress-based topology optimization of a structure on a computational device, comprising the steps of:
receiving first data at an input device coupled to an input of the computational device the first data pertaining to a problem definition of the structure;
generating a density filter;
generating interpolation schemes for stiffness, volume and stress;
generating a global stress measure;
generating an adaptive normalization scheme;
generating a regional stress measure;
generating second data based on the first data, the density filter, the interpolation schemes, the global stress measure, the adaptive normalization scheme and the regional stress measure, the second data pertaining to an optimized solution to the problem definition; and
displaying the optimized solution at an output device coupled to an output of the computational device.

2. The method of claim 1, wherein the interpolation schemes includes a solid isotropic material with penalization (SIMP) model for stiffness and volume.

3. The method of claim 1, wherein the first data includes information pertaining to geometric features of the structure, material features of the structure, and stress constraints imposed upon the structure;

4. The method of claim 1, wherein the first data includes finite element analysis information, material model information, filter radius information and load distribution information.

5. The method of claim 1, wherein the second data includes information pertaining to maximum stress and compliance values.

6. The method of claim 1, wherein the output device is a monitor configured to display the optimized solution as structural design images representing density and stress distributions.

7. The method of claim 1, wherein the adaptive normalization scheme relies upon previous optimization iteration information to normalize the global stress measure.

8. The method of claim 1, wherein the regional stress measure defines a plurality of regions that are interlaced based on elements that are sorted according to respective stress levels.

9. A system for performing stress-based topology optimization of a structure, comprising:
an input device;
an output device; and
a computational device having a microprocessor and a memory for storing an algorithm for performing stress-based topology optimization, the algorithm configuring the computational device to:
receive first data at the input device, the first data pertaining to a problem definition of the structure,
generate a density filter,
generate interpolation schemes for stiffness, volume and stress,
generate a global stress measure,
generate an adaptive normalization scheme,
generate a regional stress measure,
generate second data based on the first data, the density filter, the interpolation schemes, the global stress measure, the adaptive normalization scheme and the regional stress measure, the second data pertaining to an optimized solution to the problem definition, and
output the second data to the output device.

10. The system of claim 9, wherein the algorithm further configures the computational device to temporarily store the first data within the memory.

11. The system of claim 9, wherein the interpolation schemes includes a solid isotropic material with penalization (SIMP) model for stiffness and volume.

12. The system of claim 9, wherein the output device is a monitor configured to display the optimized solution as structural design images representing density and stress distributions.

13. The system of claim 9, wherein the first data includes information pertaining to geometric features of the structure, material features of the structure and stress constraints imposed upon the structure.

14. The system of claim 9, wherein the first data includes finite element analysis information, material model information, filter radius information and load distribution information.

15. The system of claim 9, wherein the second data includes information pertaining to maximum stress and compliance values.

16. The system of claim 9, wherein the adaptive normalization scheme relies upon previous optimization iteration information to normalize the global stress measure.

17. The system of claim 9, wherein the regional stress measure defines a plurality of regions that are interlaced based on elements that are sorted according to respective stress levels.

18. A computer program product comprising a computer-readable medium having control logic stored therein for configuring a computer to perform stress-based topology optimization for a given problem definition, the control logic comprising:
first program code for configuring the computer to generate a density filter;
second program code for configuring the computer to generate interpolation schemes for stiffness, volume and stress;
third program code for configuring the computer to generate a global stress measure;
fourth program code for configuring the computer to generate an adaptive normalization scheme; and
fifth program code for configuring the computer to generate a regional stress measure.

19. The computer program product of claim 18 further comprising sixth program code for configuring the computer to generate an optimized solution based on the problem definition, the density filter, the interpolation schemes, the global stress measure, the adaptive normalization scheme and the regional stress measure.

20. The computer program product of claim 19, wherein the optimized solution enables rendering of structural design images to display density and stress distributions.
